(19) United States
(12) Patent Application Publication
(10) Pub. No.: US 2004/0064988 A1
(43) Pub. Date: Apr. 8, 2004

(54) Poster suspension device

(76) Inventor: Michael Schoning, Waldfeucht (DE)

Correspondence Address: WILLIAM COLLARD, COLLARD & ROE, P.C., 1077 NORTHERN BOULEVARD, ROSLYN, NY, 11576, US

(21) Appl. No.: 10/467,650

(22) PCT Filed: Feb. 6, 2002
(86) PCT No.: PCT/DE02/00424

(30) Foreign Application Priority Data
Feb. 16, 2001 (DE) 101 07 778.5
Nov. 29, 2001 (DE) 101 58 407.5

(51) Int. Cl. G09F 11/18

(52) U.S. Cl. 40/518; 40/471

(57) ABSTRACT

The invention relates to a poster suspension device comprising a poster sheet. Said poster sheet, while under longitudinal tension, can be displaced in a to and fro manner between rollers, which are arranged one above the other at a distance, and from roller to roller in a direction of transport. The poster sheet is comprised of at least two individual posters. The aim of the invention is to enable individual posters to be separated from the sheet or to be placed in the sheet. To this end, connecting means, which can be removed between the poster surfaces themselves as well as in their edge reinforcements, are provided between at least two individual posters that follow one another in the longitudinal direction of the poster sheet.

### DESCRIPTION

The invention relates to a poster suspension device comprising a poster sheet that can be rolled back and forth under longitudinal tension in the direction of transport between two rolls that are arranged one on top of the other and spaced from each other. The poster sheet comprises at least two individual posters, one following the other along a line of separation in the longitudinal direction of the sheet, whereby the lateral longitudinal edges of the poster sheet, which are extending in the direction of transport, each have an edge reinforcement that is substantially consisting of a bridge resting flatly against the poster sheet, and a welt located on the outermost edge of the sheet, and whereby retaining means are associated with the edge reinforcements in the area between the rolls. These edge reinforcements are substantially reaching from one roll to the other and are serving as lateral guides of the poster sheet for receiving transverse forces acting in the poster sheet transversely to the direction of transport.

In general, the poster sheet is moved back and forth in the device specified above vertically. However, the invention is not limited to the vertical direction of transport. On the one hand, the picture or poster shown put up between the rolls may be inclined against the vertical line; on the other hand, the movement of the picture may take place in a direction extending in a slanted to a transverse manner in relation to the vertical line, i.e. the picture may move horizontally as well. Therefore, if only the embodiment with the vertical direction of transport or with the vertically suspended picture is explained or claimed here and in the following, any deviations from the vertical line are included as well.

The poster suspension device is expected to be suited for displaying a poster in its full size. At the same time, it is expected to be possible to assemble two or more individual poster pictures, so that a web of posters is formed. This poster web is to be rolled from the one roll to the other and back in sections that make it possible to view the individual poster picture. This is then referred to as a poster changer.

If such a poster changer has to be set up outdoors, the entire arrangement is surrounded by a display case which, on the viewing side, has a window made of, for example glass or a transparent plastic. An advertising showcase of this type is described in DE 295 10 670 U1. If the sight area to be presented in a given case is exceeding a defined size, for example a size of 3 by 4 m, problems arise when the transparent front pane is transported to the site of installation and handled there.

Poster materials exist that are weather-proof in such a manner that a front pane of the described advertising showcase per se would not be needed even if the showcase is set up outdoors. In general, it is possible to consider materials for this purpose that are insensitive to moisture, for example webs of plastic, textile, coated paper or metal foil materials. Good results were obtained in practical applications with vinyl webs. However, in practical life, the pane is nonetheless required in most cases if the poster web put up between the rolls is exposed not only to sunlight and rain, but also to wind or storm. Even draft air in a hall can cause the poster web put up between the rolls to flutter if the front pane of the advertising showcase is missing.

A poster suspension device of the type specified above is described in DE 200 10 731 U1. The device has an upper and a lower roll. A poster web comprising a plurality of posters is rolled back and forth between the rolls under longitudinal tension. In addition, this poster suspension device comprises retaining means for applying a transverse tension to the poster web. The aim here is to make it possible that the poster web will be capable of withstanding stresses caused by wind gusts as well as other weather influences, and that the web can be rolled up in an even manner without forming folds. As means for applying the transverse tension, it is proposed in the last-mentioned DE 200 10 731 U1 to equip the lateral longitudinal edges of the poster web with edge reinforcement means, or so-called welts, and to associate such retaining means with the reinforced edges. These retaining means each have a groove extending from one roll to the other. The grooves are extending across the welts of the reinforced edges from the sides, engaging the latter like a pair of pliers over the entire length of the visible poster picture. The groove is formed in such a manner that the welts are supported in the groove when the poster web is subjected to tensile stress in the transverse direction. “Welts” are elastic edge reinforcements of a flat web, for example in the form of a cord or a rail made of plastic, or a coil spring made of metal. The welts can be molded onto a bridge that is secured on the web (on one or both ides of the web). When the poster web is rolled on for the purpose of changing the poster, the reinforced edges are expected to slide along in the grooves. This means that notable forces of friction have to be overcome when the poster web is moved on.

For the purpose of overcoming the forces of friction occurring in the known art when the web is moving, or in particular when it is starting to move, it is proposed in EP 11 22 708 A2 to replace the grooves of the retaining means, which are extending through from one roll to the other, with individual guide heads that are arranged on each of the surfaces of the poster web with a distance between each other, whereby a guide head on the opposite surface of the poster web is disposed opposite each guiding head facing a surface of the poster web, so as to form a pair of guide heads. Such a pair of guide heads is expected to engage the welt from the sides like a pair of pliers, and to be therefore capable of tensioning the web in the direction transversely to the direction of transport. In practical life, the necessity arises that another poster has to be inserted in, or a poster has to be eliminated from a poster web that has been completely prepared. In such a case, if it has to be avoided to reprint the web again as a whole, it has to be separated in the respective location. If this is necessary, a possibility has to be found for reconnecting the poster web so as to form a through-extending web again after a single poster has been separated from it, or for the purpose of inserting another individual poster. It is deemed very desirable to realize the respective means for separating or connecting the web in such a manner that the removal or insertion of a poster on site, i.e. in connection with a poster changer that is set up outdoors and thus exposed to wind and weather, can be handled by a single person, if possible at all. The invention is also based on the task of overcoming this problem in particular as far as the area of the edge reinforcement is concerned.

The solution as defined by the invention lies in that provision is made on the line of separation between at least two individual posters disposed successively in the longitudinal direction of the poster web, for detachable connecting means both between the surfaces of the poster and in their edge reinforcements, and in that the respective welt is continuing to extend along the connection means. Provision is preferably made for the respective edge reinforcements for a connecting means in the form of a sleeve that, along the line of separation, is extending at the same time across two end pieces of the edge reinforcement abutting a longitudinal edge of the web, engaging the end pieces from the longitudinal edge of the web in a form-locked manner. Such a sleeve has an external shape corresponding with the one of the edge reinforcement with the welt, and absorbs the longitudinal tensile force exerted on the edge reinforcement. The sleeve can be referred to also as a clamp or clip. As connecting means of the poster surfaces as such, provision is made on the line of separation preferably for a type of zipper, a staple-type closure, or a Velcro closure. A number of other improvements and embodiments of the invention are specified in the dependent claims.

Lines of separation with the connection means as defined by the invention can be provided in one or more locations of the poster web. Such a line of separation is preferably inserted between each two individual posters and at the start or end of the poster web, or within a sequence of poster pictures. The invention permits separating a single poster picture from a web, or inserting it in a finished web. This work can be carried out on site outdoors, with exposure to wind and weather.

The detachable connecting means have to be stable both within the area of the web and in the area of the edges of the web, to such an extent that such connecting means are capable of absorbing the longitudinal forces exerted on the poster web. This applies in particular to the edge reinforcements located within the marginal zone of the poster web. In this site, provision is made according to the invention for a sleeve that extends across the abutting end pieces of the edge reinforcement in a form-locked manner, starting from the longitudinal edge of the web, engaging such end pieces like a clamp. The term “sleeve” particularly denotes a cover that flatly rests against the welt and the bridge and, quasi like a clamp, engages the two areas of the web from the edge of the web across the edge reinforcement, approximately reproducing its shape on its external surface.

So as to make it possible that the poster web can be moved back and forth in the direction of transport without getting wedged (along the edges) and without any interfering forces of friction, the sleeve itself as well is designed in such a way that it will not obstruct the smooth movement of the poster web in any interfering way. While the edge reinforcement or the welt is made of a flexible, elastic material that is wear-proof and can be smoothly wound up on the rolls, the sleeve can be made of a material that will rest as smoothly as possible against the edge reinforcement in a form-locked manner, in particular against the welt itself. The sleeve can be produced from polyurethane in the form of an injection-molded component that will exactly fit the edge reinforcement as a whole. If a clip closure of the commonly used type does not suffice for securing the sleeve on the edge reinforcement for absorbing the tensile force exerted on the poster web (in the direction of transport), the sleeve can be additionally connected with the edge reinforcement within the area of its bridge in a form-locked and/or force-locked manner, for example by means of bolts, rivets or screws extending vertically in relation to the surfaces of the bridge and web, or by means of a toothed connection system or the like. The sleeve may also extend over a larger distance, under certain circumstances even beyond the total length of the poster web, so that no step at all occurs on the respective lines of separation.

Within the framework of the invention, the retaining means can be provided in the form of rails with a C-shaped cross section that extend over the welts, whereby the gap width remaining in connection with the C-shaped cross section is smaller than the thickness of the welt, but larger than the thickness of the bridge. However, such a C-rail causes considerable friction when the poster web is moving. Therefore, it is preferred within the framework of the invention to realize the retaining means in the form of individual rollers, for example ball or cylindrical rollers, which are arranged on the surfaces of the poster web or the welt bridge with a spacing from one another, whereby provision is preferably made for cylindrical rollers that oppose each other in pairs with respect to the surface of the web. The axles of such rollers may be disposed approximately transversely in relation to the longitudinal direction of the web, and in parallel in relation to the surface of the poster web.

If the respective retaining means, i.e. both the C-rails and the pairs of rollers, are intended to guide a poster web with edge reinforcements that comprise in the area of the lines of separation individual sleeves on each of the edges of the web, the spacing of the components of the retaining means extending across the welt like pliers has to be adequately large for permitting the sleeve to slide into the retaining means and through the latter without any obstruction. This may lead to the fact that the area of the edge reinforcement without the sleeve is no longer engaged by the respective retaining means with adequate safety. The situation may become critical in that regard primarily in the locations where the areas without the sleeve of the welts are expected to run into the retaining means (at their longitudinal end).

Since the poster web has to be put up with a certain transverse force exerted by the retaining means, it is necessary, as a rule, to pull the poster web outwards on the respective longitudinal end of the retaining means. The insertion of the welt in the retaining means will nonetheless not pose any problem as long as the welt is adequately thick in the direction perpendicular to the surface of the poster. However, this thickness of the welt also has drawbacks because as the length of the poster web increases, the thickness of the welt makes it more difficult to wind the web on a roll, because the diameter of the wound web is increasing substantially more rapidly in the area of the edge reinforcement than the diameter of the reeled-up remainder of the web.

It would be conceivable to make the edge reinforcement, including the welt, thinner adjacent to the respective line of separation before mounting the sleeve, for example by grinding or milling, so that the area with the sleeve would be provided with approximately the same thickness as the main area without the sleeve. However, this idea cannot be realized in practical life mainly for cost reasons because this would require an expert, and it would have to be implemented in a free-handed manner on a device that is set up high above the ground, as a rule.

So as to deal with these problems, provision is made according to a further invention that the retaining means, in the presence of a welt thickness that is substantially remaining unchanged, are adapted to the thickness—which is measured vertically to the surface of the poster web—of the sleeve that is mounted on the respective line of separation in a fixed manner, and provision is made for insertion funnels on the longitudinal ends of the retaining means that are facing the upper and lower rolls. Such insertion funnels are absorbing the transverse forces exerted by the poster web. The transverse force acting in the poster web is cancelled by the insertion funnels before the welt runs into the respective retaining means, so that also a conventional welt that could pose problems when it is threaded into the retaining means that has been expanded because of the sleeve, for example due to canting and jamming, is guided into the retaining means in a straight line. The dimensions of the welt and the retaining means can be easily selected in this connection in such a manner that a welt, once it has properly run into the retaining means, cannot be pulled from the retaining means “expanded” on account of the sleeve in the presence of normal transverse forces, because a welt cannot cant within the retaining means, as it cannot on the inlet.

According to yet another invention, provision is made for a slanted pair of rolls, which are extending over the sleeve like a pair of pliers. The axles of the rolls of such a pair of rolls are set inclined in relation to the surface of the poster web, and its individual rolls are supported on the welt. This solution is particularly beneficial in conjunction with the aforementioned retaining means consisting of paired rolls. In this case, rolls are preferred that have cylindrical running surfaces with respect to the roller axis. If the rolls are set slanted in relation to the surface of the web, the rolls will touch the surface of the web or the bridge of the edge reinforcement or sleeve, on the one hand, and the welt, on the other, substantially only with an edge of the cylinder, thus substantially only along a line, and consequently with relatively low friction. The slanted pairs of rolls therefore can be arranged with a smaller mutual spacing than the other pairs of rolls, the roll axles of which and thus their cylindrical running surface, if necessary, are to be set preferably approximately parallel in relation to the surface of the web (with the axle disposed transversely in relation to the direction of transport). Because of the smaller mutual spacing of their individual rolls, such spacing amounting to only 0.3 mm in terms of the order of magnitude, the pairs of inclined rolls serving as insertion funnels are capable of seizing the poster web in the inlet area of the respective retaining means without any risk of canting, and of pulling the poster web apart in the cross direction in such a way that the respective welt can run into the retaining means in a straight line.

One pair of slanted rolls generally suffices as an insertion funnel at each longitudinal end of the retaining means. However, it is preferred that provision is made for at least two pairs of slanted rolls at the longitudinal ends of the retaining means, with the running surfaces of these rolls facing the bridge and the welt at the same time. These pairs of slanted rolls are then capable of tensioning the poster web in the insertion area of the retaining means in the transverse direction even in the presence of strong wind effects acting on the poster web, in a manner such that the welts can run into the retaining means without canting.

Details of the invention are explained with the help of a schematic representation of an exemplified embodiment. In the drawing,

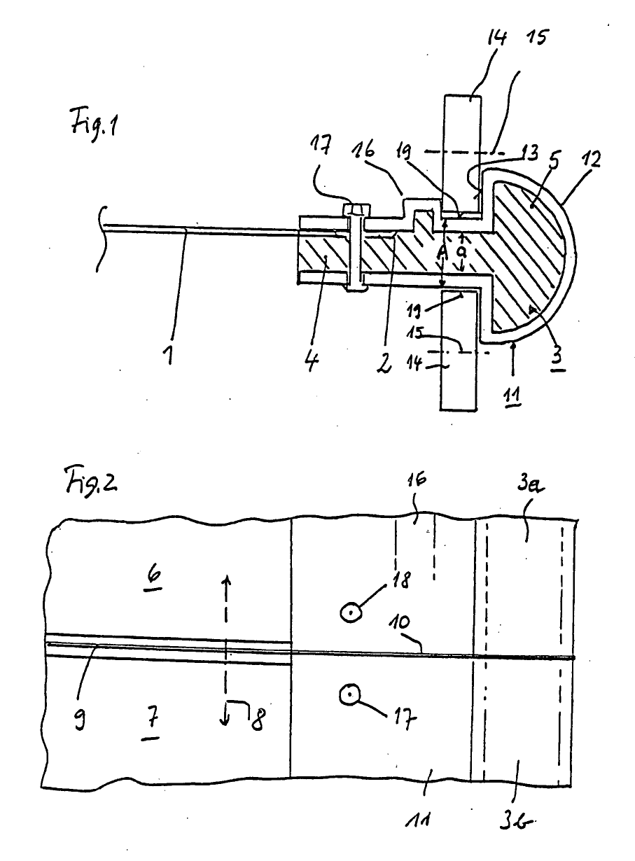

FIG. 1 is a section through an edge reinforcement perpendicular to the poster web.

FIG. 2 is a top view of the edge zone of the poster web according to FIG. 1.

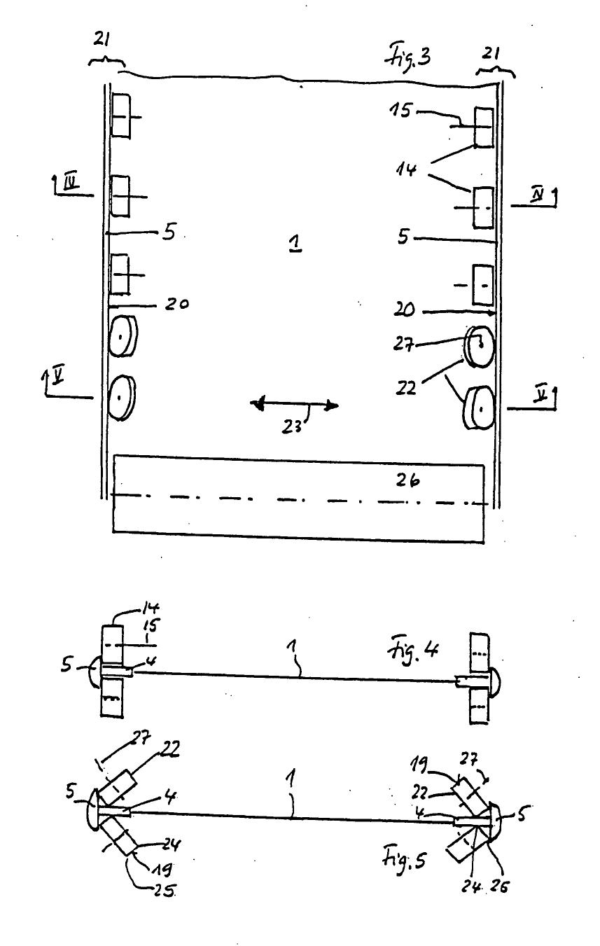

FIG. 3 is a top view of the poster web between two retaining means equipped with pairs of rolls; and

FIGS. 4 and 5 are sections along the lines IV-IV and V-V of FIG. 3.

In FIG. 1, an edge reinforcement attached to the poster web 1 on an edge 2 is denoted as a whole by 3. The edge reinforcement 3 is comprised of a ribbon-like strip or bridge 4, and the actual bead-like welt 5. As drawn in this figure, the bridge 4 can be provided on one surface or both surfaces of the poster. FIG. 2 shows the two individual posters 6 and 7, which are under tension in the longitudinal direction 8 of the web, and connected with each other by a detachable connecting means, which is preferably a zipper 9.

According to FIGS. 1 and 2, a sleeve denoted as a whole by 11 is pushed or clamped like pliers over the parts 3a and 3b of the edge reinforcement 3 that abut each other along the separation line 10 of the individual posters 6 and 7. The sleeve is shaped in such a way that it surrounds the edge reinforcement 3 (3a, 3b) as tightly as possible in all parts. On its external surface, the sleeve 11 has to reproduce as exactly as possible the external shape primarily of the bead-like welt 5 itself. In the exemplified embodiment, the welt 5 has an approximately semi-cylindrical shape 12 on the outer edge facing away from the poster web 1, whereas toward the surface of the poster, it has the straight supporting or retaining surfaces 13 that are extending approximately vertically in relation to the surface of the poster. Especially this retaining surface 13 has to be reproduced on the external surface of the sleeve 11.

The welt 5 is supported on the aforementioned retaining means on one or both of the surfaces 13. The rollers 14 are shown by way of example as retaining means; their axles 15 are extending in parallel with the surface of the poster web 1 and perpendicular in relation to the longitudinal direction 8 of the poster web. The guidance of the poster web 1 can be enhanced with the help of the edge reinforcement 3 if a humped wall 16 is extending approximately in parallel with the retaining surface 13. Such a wall excludes any movement of the edge reinforcement 3 relative to the roller 14 in the direction of the axle 15.

For securing the sleeve 11 on the edge reinforcements 3a and 3b abutting a separation line 10, provision is preferably made for the connecting elements 17 and 18, which are arranged with a distance from the running surface 19 of the roller 14, said running surface being cylindrical in the exemplified embodiment. The connecting elements 17 and 18 may be, for example bolts, which are reaching through the two surfaces of the sleeve 11 shown in FIG. 1, and the ribbon-like strip 14 clamped in between.

The mutual spacing of the running surfaces 19 of the pair of rollers 14 of FIG. 1 has to be sufficiently large so that the bridge 4 will fit through between the running surfaces 19 in a smooth manner and without interfering friction also in the area in which the sleeve 11 is turned inside out over the bridge 4. In one exemplified embodiment, the bridge 4 had a thickness of a=2 mm between the running surfaces 19 (measured perpendicular to the surface of the web). The sleeve 11 turned inside out over the bridge increases the respective bridge thickness to A=3.6 mm. In the area of the poster web in which no sleeve 11 is placed around the edge reinforcement 3, a movement play of 1.6 mm is obtained (in addition to the usual tolerance) for the bridge 4 between the running surfaces 19 of the rollers 14. In the exemplified embodiment, such additional play has no interfering effect if the welt 15 is properly threaded through between the rollers 14, and the retaining surface 13 holding the welt is elevated by more than 1.6 mm perpendicular to the bridge 4. When it is threaded in, however, the welt 5 (without the sleeve 11) may sometimes get canted or jammed between the running surfaces 19 of the rollers 14.

In order to exclude canting, provision is made within the framework of the further invention for placing the so-called slanted rollers 22 or the pairs of the slanted rollers 22 in front of the longitudinal ends 20 of the retaining means or pairs of rollers 14, which, as a whole, are denoted by 21. The transverse forces acting in the cross direction 23 of the poster web 1 are absorbed by such slanted rollers or pairs of slanted rollers to such an extent that the respective welt 5 can be threaded into the retaining means 21 at the longitudinal end 20 in a straight line, thus behind the retaining surfaces 13.

FIGS. 4 and 5 show sectional views along the lines IV-IV and V-V of FIG. 3. Especially FIG. 5 shows an exemplified embodiment of the slanted roller pairs 22, which are rolling off with the one cylinder edge 24 of their running surface 9 on the bridge 4, or on the sleeve 11 disposed thereon, and which are supported with the other running roller edge 25 on the retaining surface 13 of the naked welt 5, or the welt 5 coated with the sleeve. Within the framework of the described embodiment of the invention, the retaining means 21 are adapted to the bridge thickness A—which is measured perpendicular to the surface of the poster web—of the sleeve 11 that is mounted on the respective separation line 10 in a fixed manner. At the same time, at the longitudinal ends 20 of the retaining means that are facing the upper and the lower rolls (the lower roll 26 is shown in FIG. 3), provision is made for insertion funnels preferably in the form of the pairs of slanted rollers 22, which absorb the transverse forces (forces in the cross direction 23) exerted by the poster web 1. If need be, the pairs of slanted rollers 22 have to extend over the edge reinforcements and the sleeve 11 like a pair of pliers—like a thumb and index finger—, whereby the roller axles 27 of the slanted rollers 22 are set inclined in relation to the surface of the poster web, and the individual slanted rollers 22 have to be supported at the same time on the bridge 4 and the welt 5 (without or without the sleeve 11 being placed over it).

The projection of the axles 27 of the slanted rollers 22 on the tensioned poster web surface has to be disposed approximately in parallel with the cross direction 23. Viewed in the section perpendicular to the surface of the web, the distance between the area of the web and the axis has to decrease along the latter, starting from the edge of the web, thus from the outside inwards. The axles thus have to be inclined toward the surface of the web, starting from the edge of the web, at an angle that is open toward the edge of the web. Preferably, the axles 27 of the upper and the lower individual rollers 22 of each pair of slanted rollers are inclined against the lower and the upper surface of the web at the same angle in the order of magnitude of from 30° to 60°, preferably of about 45°, in such a manner that the welt 5 is pressed outwards by the running surfaces of the slanted rollers 22 against the transverse force, i.e. that the running surfaces will tighten the post web 1 in the cross direction.

One single pair of slanted rollers generally suffices at each longitudinal end 20 of the retaining means 21. However, if, for example, strong transverse forces may occur, it may be beneficial to make provision for two or more pairs of slanted rollers at the longitudinal ends 20 of the retaining means. In that case, the pairs of slanted rollers may be approximately positioned as a straight continuation of the retaining means. However, it is also within the scope of the invention to displace the second, the third etc. pair of slanted rollers against the transverse direction 23 inwards, so that the welt, when passing the slanted rollers, is gradually pulled outwards, and can finally run into the retaining means in a straight line.

### List of Reference Numerals

| | |
|---|---|
| 1 = | Poster web |
| 2 = | Edge (of 1) |
| 3 = | Edge reinforcement |
| 4 = | Ribbon-like bridge |
| 5 = | Welt |
| 6, 7 = | Individual poster |
| 8 = | Longitudinal direction of web |
| 9 = | Zipper |
| 10 = | Separation line |
| 11 = | Sleeve |
| 12 = | Semi-cylindrical shape |
| 13 = | Retaining surface |
| 14 = | Roller |
| 15 = | Axle (of 14) |
| 16 = | Humped wall |
| 17, 18 = | Connecting element |
| 19 = | Running surface |
| 20 = | Longitudinal end |
| 21 = | Retaining means |
| 22 = | Slanted roller |
| 23 = | Transverse direction |
| 24, 25 = | Edges of running surface 19 |
| 26 = | Lower roll |
| 27 = | Axle (of 22) |

1. A poster suspension device with a poster web (1) adapted to roll back and forth under longitudinal tension in the direction of transport from one roll to the other between two rolls (26) arranged one on top of the other with a spacing in between, said poster web comprising at least two individual posters (6, 7) one following the other in the longitudinal direction (8) of the web on a separation line (10), whereby the lateral longitudinal edges of the poster surfaces each have an edge reinforcement (3) substantially consisting of a bridge (4) resting flatly against the poster web, and a welt (5) of the edge of the web; and whereby retaining means (21) substantially extending from one roll to the other are associated with the edge reinforcement in the area between the rolls, such retaining means serving as lateral guides of the poster web for receiving transverse forces acting in the poster web transversely to the direction of transport, characterized in that provision is made for detachable connecting means (9, 11) on the separation line (10) between two individual posters (6, 7) one following the other in the longitudinal direction (8) of the poster web (1) both between the poster surfaces as such and in their edge reinforcements (3a, 3b); and that the respective welt (5) is continuing along the connection means.

2. The poster suspension device according to claim 1, characterized in that the detachable connecting means of the respective edge reinforcements (3) is a sleeve (11) extending along the separation line (10) at the same time over two end pieces (3a, 3b) of the edge reinforcement abutting a longitudinal edge (2) of the web, in a form-locking manner starting from the longitudinal edge of the web and including the latter, with the external shape of said sleeve corresponding with the one of the edge reinforcement (3).

3. The poster suspension device according to claim 1 or 2, characterized in that the sleeve (11) is coupled with the edge reinforcement (3, 4) with the help of a clip connection, for example with the help of bolts (17, 18) or the like extending perpendicular to the surface of the poster web.

4. The poster suspension device according to one or more of claims 1 to 3, characterized in that provision is made for a zipper (9) serving as the detachable connecting means of the poster surfaces (6, 7).

5. The poster suspension device according to at least one of claims 1 to 4, characterized in that the retaining means (21) are adapted to the thickness (A) of the sleeve (11) mounted in a fixed manner on the separation line (10), said thickness being measured in the area of the bridge (4) perpendicular to the surface of the poster web; and that provision is made on the longitudinal ends (20) of the retaining means (21) facing the upper and the lower rolls (26) for insertion funnels, the latter absorbing the transverse forces exerted by the web.

6. The poster suspension device according to claim 5, characterized in that provision is made for at least one pair of slanted rollers (22) as the insertion funnel, said pair of rollers extending over the edge reinforcement (3) and, if necessary, over the sleeve (11) in the way of a pair of pliers, with the axles (27) of the rollers being set inclined with respect to the surface of the poster web, and the running surfaces (19) of the individual rollers (27) being supported at the same time both on the bridge (4) and on the welt (5).

7. The poster suspension device according to claim 6, characterized in that the axles (27) of the lower and the upper individual rollers (22) of a pair of slanted rollers are inclined against the lower and the upper surface of the web at the same angle in the order of magnitude of from 30° to 60°, preferably of about 45°, said angle being open toward the edge of the web, in a manner such that the welt (5) is pressed outwards by the running surfaces (19) of the rollers (22) against the transverse force, i.e., that the rollers tighten the poster web (1) in the transverse direction (23).

8. The poster suspension device according to claim 7 or 8, characterized in that the retaining means (21) consist of individual guide rollers (14) arranged on the surfaces of the poster web (1) with a spacing from each other, said guide rollers opposing each other in pairs with respect to the surface of the web and having their roller axles set approximately in parallel with the surface of the poster web.

9. The poster suspension device according to claim 8, characterized in that at least two pairs (22) of slanted rollers are provided at each longitudinal end (20) of the retaining means (21) in an approximately straight continuation of the pairs of guide rollers.
